(19) United States
(12) Patent Application Publication
(10) Pub. No.: US 2026/0040408 A1
(43) Pub. Date: Feb. 5, 2026

(54) HEATING ASSEMBLY AND METHOD FOR A PROCESSING CHAMBER

(71) Applicant: Applied Materials, Inc., Santa Clara, CA (US)

(72) Inventors: Christian GRONET, Santa Clara, CA (US); David Masayuki ISHIKAWA, Mountain View, CA (US); Brian BURROWS, San Jose, CA (US); Kelvin CHAN, San Ramon, CA (US)

(21) Appl. No.: 18/792,484

(22) Filed: Aug. 1, 2024

(51) Int. Cl. H05B 3/00

(52) U.S. Cl. CPC H05B 3/0038; H05B 3/0047

(57) ABSTRACT

Disclosed herein are a reflector apparatus for a heating assembly, and a method for operating the heating assembly. The reflector apparatus includes a base that has a first side having openings for radiation to pass through, a second side opposite to the first side, and a side wall extending between the first side and the second side. The reflector apparatus further includes a first reflector pocket disposed between the first side and the second side of the base and having a first reflector portion. The first reflector portion may include a wavy section having a Fresnel shape. A first reflector cooling chamber encases the first reflector portion and the wavy section. The method includes operating a heating lamp disposed in a reflector pocket at a power of at least 600 W and circulating a coolant within a reflector cooling chamber to cool the heating lamp.

### BACKGROUND

### Field

The present disclosure relates to a heating assembly and method for a semiconductor processing chamber, and, more specifically, relates to a heating assembly and method for operating high powered heating lamps.

### Description of the Related Art

Semiconductor manufacturing often require processing substrates at elevated processing temperatures. A heating assembly is used in a processing chamber to heat the substrate to desired temperatures. Conventional heating assemblies for a processing chamber do not have a rapid temperature ramping rate. For example, the conventional heating assemblies may only be able to increase the processing temperature up to about 4 (four) degrees Celsius per second. This heating rate may be adequate when the processing temperature is less than 1,000 degrees. But, silicon carbide (SiC) substrates need a much higher temperature than conventional silicon substrates. For example, SiC substrates may need a processing temperature as high as 1800^{o} C.

The conventional heating assemblies are not suitable for in processing SiC substrates for mass production. First, the ramp-up rate of the processing temperature is too low, thus limiting the throughput of the processes. Second, the conventional heating assemblies do not have adequate cooling capacity and efficiency to cool high powered heating elements. When a powerful filament is used to increase the heat output of a conventional heating assembly, the temperature of the conventional heating assembly itself can be high enough to damage certain parts of the assembly. For example, the quartz housing that protects the filament can suffer an early meltdown due to the high output of the power.

Thus, a need exists for an improved heating assembly for processing substrates at a high temperature.

### SUMMARY

Disclosed herein are a reflector apparatus for a heating assembly, and a method for operating the heating assembly. In an example, a reflector apparatus for a processing chamber includes a base. The base includes a first side having openings for radiation to pass through, a second side opposite to the first side, and a side wall extending between the first side and the second side. The base further includes a first reflector pocket disposed between the first side and the second side of the base and having a first reflector portion. The first reflector portion includes a wavy section having a plurality of peaks and valleys.

In another example, the reflector apparatus includes a base. The base includes a first side having openings for radiation to pass through, a second side opposite to the first side, and a side wall extending between the first side and the second side. The base further includes a first reflector pocket disposed between the first side and the second side of the base and having a first reflector portion. The reflector apparatus further includes a first reflector cooling chamber encasing the first reflector portion. The reflector apparatus includes a supply plenum and a return plenum for flowing a heat transferring fluid to the first reflector cooling chamber. The first reflector pocket also includes a Fresnel shape for efficiently reflecting radiations out of the first reflector pocket.

In another example, the heating assembly includes a base comprising a radiation side, a socket side, and a side wall extending between the radiation side and the socket side; a plurality of reflector pockets disposed in the base between the radiation side and the socket side and comprising a first reflector pocket that comprises a first reflector portion, the first reflector pocket further comprising a first reflector cooling chamber encasing the first reflector portion; and a plurality of heating lamps disposed within the plurality of the reflector pockets, the plurality of heating lamps comprising a first heating lamp disposed within the first reflector pocket, the first heating lamp comprising a filament enclosed by a housing, the first reflector cooling chamber extending beyond a top end of the filament.

In another example, the method for operating the heating assembly includes powering a heating lamp disposed in a reflector pocket of the heating assembly with at least 600 W of electricity, the reflector pocket comprising a reflector cooling chamber encasing a reflector portion of the reflector pocket; and circulating a coolant within the reflector cooling chamber to reach a first location that is no longer than 1 mm away from a surface of a housing of the heating lamp and a second location that is higher than a top end of a filament of the heating lamp.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 illustrates a schematic top view of a processing system, according to an embodiment of the present disclosure.

FIG. 2 illustrates a schematic cross-sectional view of a rapid thermal processing chamber having an improved heating assembly, according to an embodiment of the present disclosure.

FIG. 3 illustrates a schematic cross-sectional view of a deposition chamber having an improved heating assembly, according to an embodiment of the present disclosure.

FIG. 4 illustrates a perspective cross-sectional view of a reflector base, according to an embodiment of the present disclosure.

FIG. 5A illustrates a schematic cross-sectional view of a heating lamp disposed within a reflector pocket, according to an embodiment of the present disclosure.

FIG. 5B illustrates a schematic cross-sectional view of a reflector portion of a reflector pocket, according to an embodiment of the present disclosure.

FIG. 5C illustrates a schematic cross-sectional view of a heating lamp disposed within a reflector pocket, according to an embodiment of the present disclosure.

FIG. 6 illustrates a schematic top view of a heating assembly dividing heating lamps into a plurality of zone groups, according to an embodiment of the present disclosure.

FIG. 7 illustrates a method for operating a heating assembly, according to an embodiment of the present disclosure.

FIG. 8a illustrates a schematic top view of a circulation network of a cooling zone, according to an embodiment of the present disclosure.

FIG. 8b illustrates a schematic cross-sectional view of a circulation network around a heating lamp, according to an embodiment of the present disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The disclosure contemplates that terms such as “couples,” “coupling,” “couple,” and “coupled” may include but are not limited to welding, fusing, melting together, interference fitting, and/or fastening such as by using bolts, threaded connections, pins, and/or screws. The disclosure contemplates that terms such as “couples,” “coupling,” “couple,” and “coupled” may include but are not limited to integrally forming. The disclosure contemplates that terms such as “couples,” “coupling,” “couple,” and “coupled” may include but are not limited to direct coupling and/or indirect coupling, such as indirect coupling through components such as links, blocks, and/or frames.

Disclosed herein is a heating assembly having an improved reflector apparatus. The reflector apparatus is capable of accommodating high powered radiation lamps of at least 600 W, 800 W, 1,000 W or even a higher power. The high powered radiation lamps are capable of heating the temperature of a susceptor disposed in a processing chamber to at least 1,000^{o} C, 1,500 ^{o} C, 1,800 ^{o} C or even higher. A reflector pocket formed in the reflector apparatus includes a reflector portion disposed close to a housing of the high powered radiation lamps. Cooling chambers or jackets are formed around the reflector portion and may extend substantially between two sides of the reflector base. The two sides include a first side and a second side opposite to the first side. The first side may be understood as a side that faces a susceptor or a substrate when the heating assembly is placed in a processing chamber. The first side has openings that allow radiation to pass through and may also be called a front side or a radiation side. The second side has sockets configured with heating lamps and may be called a back side or a socket side. An additive manufacturing process, such as a 3D-printing process, can be used to fabricate the reflector base. Thus, the base can have very complex internal chambers and channels formed by thin structures, which further increase the heat dissipation efficiency. The thin structures also allow a heat transferring fluid to be circulated in a very close proximity to the heating lamps.

The reflector portion may have a complex shape, such as a Fresnel shape, which is configured to direct a large portion of the radiation within the reflector pocket toward a susceptor disposed above the heating assembly. The complex shape may be selected according to the temperature profile of the radiation lamp and/ the reflectivity profile of the reflector pocket.

The cooling chambers, which conform to the complex shape, can efficiently cool the housing of the radiation lamp by having the heat transferring fluid circulate in close proximity to the high temperature spots of the radiation lamps. As a result, the temperature of the housing of the lamp can be cooled to about 100 degrees Celsius, although the filament’s temperature may be above 3,000 degrees Celsius.

The reflector apparatus configured according to various embodiments of the present disclosure has an improved heating efficiency that allows a high powered radiation lamp to heat a susceptor rapidly, such as about 40 ^{o} C/second. The reflector base can also efficiently cool the high powered radiation lamp even after a long period of operation. For example, an 800 W heating lamp can be operated at full capacity within the reflector apparatus for longer than 10 minutes without suffering any visible damage, such as deformation of the quartz housing of the heating lamp.

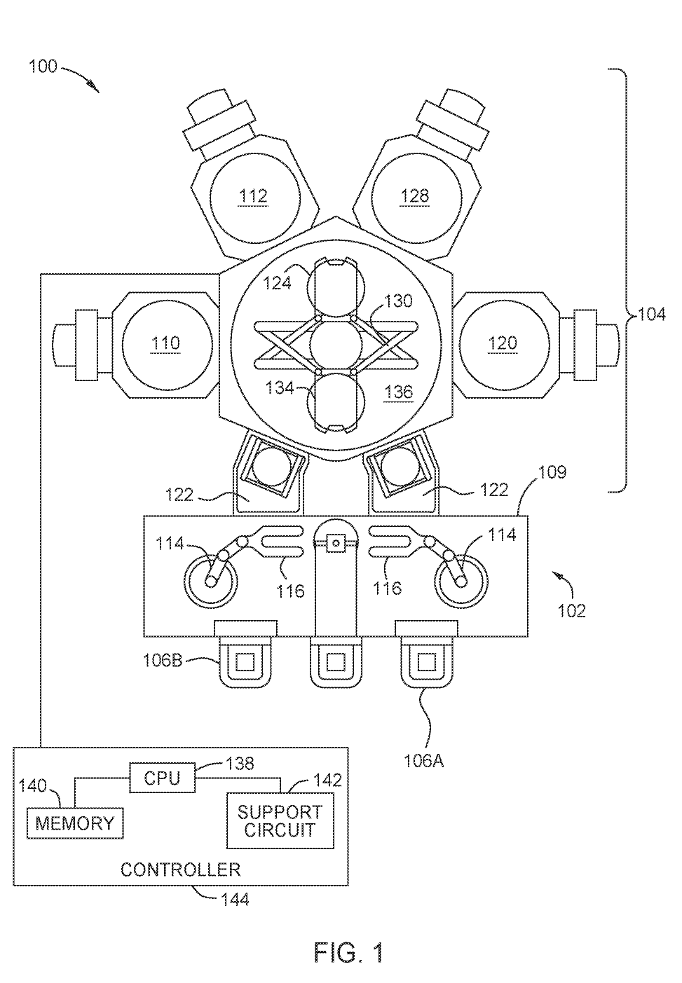

FIG. 1 illustrates a schematic top view of a processing system 100, according to one or more embodiments. The processing system 100 includes a heating assembly as described in the present disclosure. The processing system 100 includes one or more load lock chambers 122 (two are shown in FIG. 1), a processing platform 104, a factory interface 102, and a controller 144. In one or more embodiments, the processing system 100 may be adapted based on a CENTURA^{®} integrated processing system provided by Applied Materials, Inc., located in Santa Clara, California. It is contemplated that other processing systems (including those from other manufacturers) may be adapted to benefit from the present disclosure.

The processing platform 104 includes a plurality of processing chambers 110, 112, 120, 128, and a transfer chamber 136. The plurality of processing chambers 110, 112, 120, 128 may include an atomic layer deposition (ALD) chamber, an epitaxy deposition (EPI) chamber, a physical vapor deposition (PVD) chamber, a chemical vapor deposition (CVD) chamber, a molecular beam epitaxy (MBE) chamber, an etch chamber, a rapid thermal processing (RTP) chamber, or any other substrate processing chamber. In an embodiment, one of the plurality of processing chambers 110, 112, 120, 128 is an EPI chamber configured to process a silicon carbide (SiC) substrate at a temperature range of at least 1,000^{o} C, at least 1,200^{o} C, or at least 1,400^{o} C, or at least 1,800^{o} C

Each of the processing chambers 110, 112, 120, 128 is coupled to the transfer chamber 136. The transfer chamber 136 can be maintained under vacuum. The factory interface 102 is coupled to the transfer chamber 136 through the load lock chambers 122. Two load lock chambers 122 are shown in FIG. 1. The load lock chambers 122 are used to transfer substrates from an ambient (e.g., atmospheric) pressure environment of the factory interface 102 to the vacuum environment of the transfer chamber 136.

In one or more embodiments, the factory interface 102 includes at least one docking station 109 and at least one factory interface robot 114 to facilitate the transfer of substrates 124. The docking station 109 is configured to accept one or more front opening unified pods (FOUPs). Two FOUPS 106A, 106B are shown in the implementation of FIG. 1. The factory interface robot 114 has a blade 116 that is configured to transfer one or more substrates from the FOUPS 106A to the load lock chambers 122.

Each of the load lock chambers 122 has a first port interfacing with the factory interface 102 and a second port interfacing with the transfer chamber 136. The transfer chamber 136 has a vacuum robot 130 disposed therein. The vacuum robot 130 has one or more blades 134 (two are shown in FIG. 1) capable of transferring the substrates 124 between the load lock chambers 122 and the processing chambers 110, 112, 120, and 128.

The controller 144 is coupled to the processing system 100 and is used to control processes and methods, such as the operations of the methods described herein (for example the operations of the methods as described in other parts of the present disclosure). The controller 144 includes a central processing unit (CPU) 138, a memory 140 containing instructions, and support circuits 142 for the CPU. The controller 144 controls various items directly, or via other computers and/or controllers.

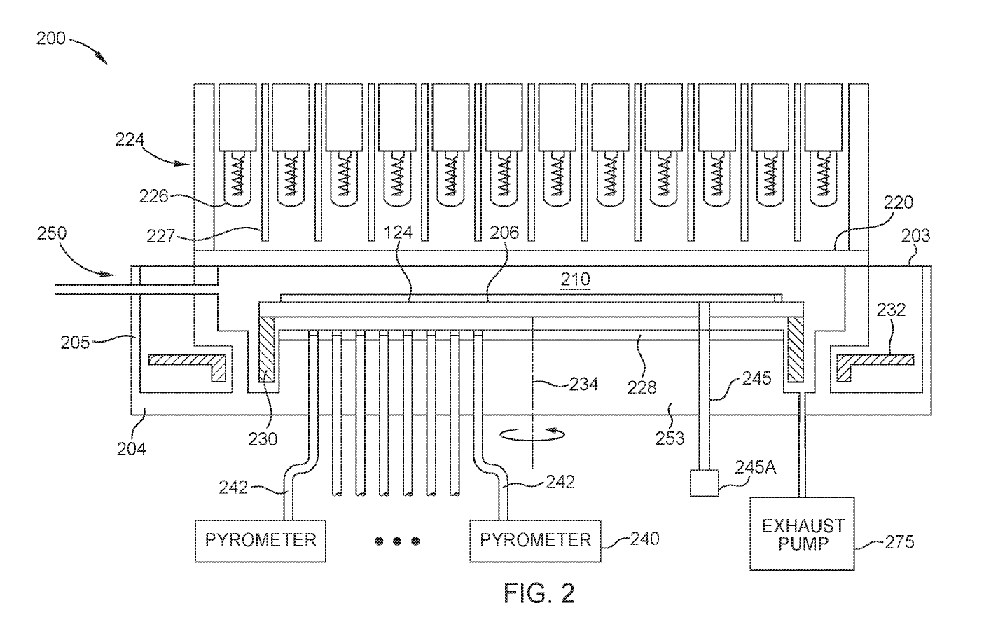

FIG. 2 illustrates a schematic cross-sectional view of a processing chamber 200, according to an embodiment. In an embodiment, the processing chamber 200 functions as a rapid thermal processing (RTP) chamber configured to rapidly heat a substrate 124 to a processing temperature. The processing chamber 200 can be one or more of the processing chambers 110, 112, 120, and 128 as shown in FIG. 1 and includes a heating assembly 224 as set forth in the present disclosure. The substrate 124 may be a transparent substrate, such as a SiC substrate, although non-transparent substrates may also be processed by the processing chamber 200.

The processing chamber 200 includes a chamber body 250 enclosing an interior volume 210. Process gases are provided into the interior volume 210, and an exhaust pump 275 removes exhaust gases from the processing chamber 200. The chamber body 250 includes a top 203, a bottom 204, and one or more sides 205 connecting the top 203 with the bottom 204. The processing chamber 200 includes a transparent window 220 that can form part of the top 203 of the chamber body 50. The processing chamber 200 includes a rotatable flange 232. A rotor (not shown) rotates the rotatable flange 232 about the central axis 234.

The processing chamber 200 includes a susceptor 206 coupled with a cylindrical ring 230. The susceptor 206 shown in FIG. 1 is merely an example of a substrate support structure. The processing chamber 200 may use any other suitable substrate support structures. The susceptor 206 supports the substrate 124. The substrate 124 can be lifted up or lowered down by the lift pins 245. In an embodiment, the cylindrical ring 230 may be magnetically coupled to the rotatable flange 232. Thus, the rotation of the flange 232 can cause the cylindrical ring 230 to rotate, which, in turn, causes the substrate 124 and the susceptor 206 that are positioned on the cylindrical ring 230 rotate. In an embodiment, the susceptor 206 and the cylindrical ring 230 may be rotated independently from the flange 232.

The processing chamber 200 further includes a heating assembly 224 positioned above the susceptor 206. The heating assembly 224 is configured according to various embodiments of the present disclosure. The heating assembly 224 can include a plurality of lamps 226 disposed within a reflector apparatus 227. The reflector apparatus 227 may also be referred to as a lamphead. In an embodiment, the plurality of lamps 226 include high-intensity tungsten-halogen lamps arranged in a hexagonal close-packed array above the transparent window 220. The heating apparatus 224 can rapidly heat the substrate 124 in the interior volume 210 at rates greater than 40°C/second to temperatures as high as 1800°C. The heating assembly 224 also includes a plurality of cooling channels (not shown in FIG. 2).

The processing chamber 200 further includes a reflective member 228 positioned below the susceptor 206 and supported on a base 253. The reflective member 228 can be used to reflect radiation back towards the substrate 124 and susceptor 206. The reflective member 228 can include holes that allow the lift pins 245 to extend and retract through the reflector 228 to raise and lower the susceptor 206. Each lift pin 245 can be connected to a lift pin actuator 245A, positioned below the reflective member 228.

The processing chamber 200 can further include a plurality of pyrometers 240, each coupled with a light pipe 242 that extends from a pyrometer to a location below the susceptor 206. The pyrometers 240 are configured to receive radiation by the susceptor 206 through light pipes 242 to monitor temperatures at different locations (e.g., different radial locations) on the substrate 124.

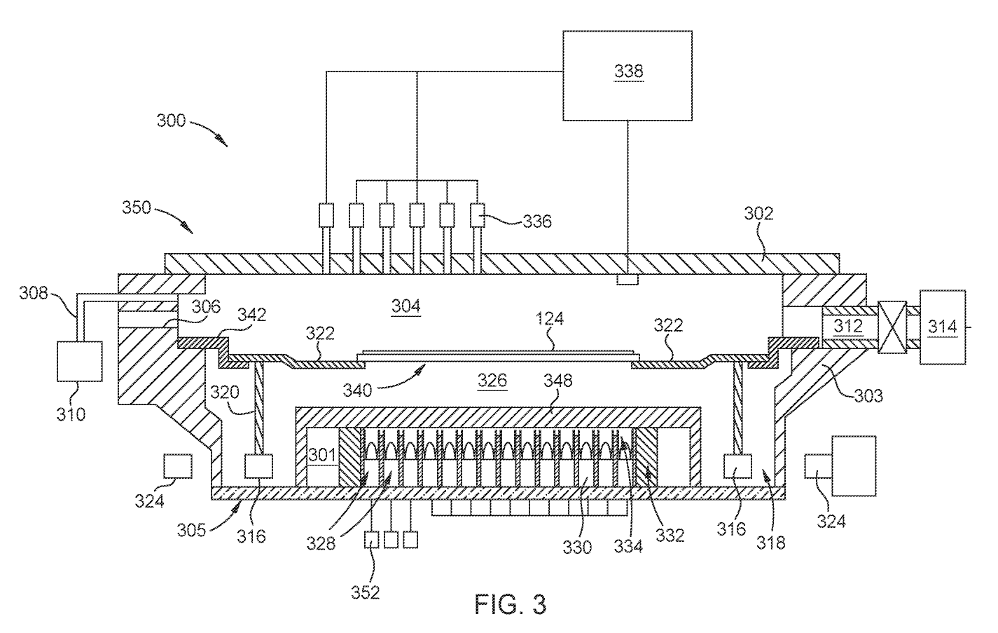

FIG. 3 illustrates a schematic cross-sectional view of a processing chamber 300, according to an embodiment of the present disclosure. In an embodiment, the processing chamber 300 functions as an epitaxy deposition chamber configured to deposit one or more layers of materials on a substrate 124. Comparing with the RTP chamber 200 in FIG. 2, a heating assembly 301 of the processing chamber 300 is positioned under a substrate 124. The processing chamber 300 can be one or more of the processing chambers 110, 112, 120, and 128 as shown in FIG. 1, and the heating assembly 301 is configured according to various embodiments as set forth in the present disclosure.

The processing chamber 300 includes a chamber body 350 enclosing a processing volume 304 for processing the substrate 124. The chamber body 350 includes a top section 302, a side section 303, and a bottom section 305. A slit valve 306 may be formed on a side of the chamber body 302 providing a passage for the substrate 124 to be transferred into or out of the processing volume 304. A gas inlet 308 may be connected to a gas source 310 to provide processing gases, such as source gases, purge gases and/or cleaning gases, to the processing volume 304. A vacuum pump 314 may be fluidly connected to the processing volume 304 through an outlet 312 for pumping out effluent gases.

The substrate 124 is supported by a susceptor 340, which is supported by an edge ring 322 disposed on a tubular member 320. An outer ring 342 covers a gap between the chamber body 302 and the edge ring 322. The tubular member 320 rests on or otherwise coupled to a magnetic rotor 316. The magnetic rotor 316 is disposed in the circular channel 318. A magnetic stator 324 is located externally of the magnetic rotor 316 and is magnetically coupled through the chamber body 302 to induce rotation of the magnetic rotor 316 and hence of the edge ring 322 and the substrate 124 supported thereon. The magnetic stator 324 may be also configured to adjust the elevations of the magnetic rotor 316, thus lifting the substrate 124 being processed.

The heating assembly 301 may include a plurality of heating elements 328 disposed in a reflector apparatus 332. The reflector apparatus 332 may be referred to as a lamphead. The array of heating elements 328 may be UV lamps, halogen lamps, laser diodes, resistive heaters, microwave powered heaters, light emitting diodes (LEDs), or any other suitable heating elements both singly or in combination. Each heating elements 328 may be disposed in a reflector pocket 330 formed in the reflector apparatus 332. In one embodiment, the heating elements 328 may be arranged in a hexagonal pattern. A cooling network 334 are formed in the reflector apparatus 332. A heat transferring fluid, such as water, may be circulated inside the cooling network 334. An optional transparent dome 348 may be disposed between the heating assembly 301 and the susceptor 340.

A protective region 326 is formed between the heating assembly 301 and the susceptor 340 and is configured to protect components disposed between the susceptor 340 and the bottom section 305, such as the backside of the susceptor 340 and the heating assembly 301. In an embodiment, the protective region 326 is filled with a purge gas, such as an inert gas (argon, helium, and other suitable inert gases), to prevent processing gases in the processing volume 304 from reaching the backside of the susceptor 340 and the heating assembly 301, thereby preventing deposition on such components. The processing volume 304 and the protective region 326 may have different environments, such as different gases, different gas pressures, and different temperatures. In an embodiment, the pressure of the protective region 326 is higher than the processing volume 304. The protective region 326 is separated from the processing volume 304 by the susceptor 340, edge ring 322 and outer ring 342.

In one embodiment, the heating elements 328 may be divided into a plurality of heating groups to heat the substrate 124. Each heating group may be controlled independently by a controller 338 to provide desired temperature profile across a radius of the substrate 124. A plurality of thermal sensors 336, such as pyrometers, may be disposed above the substrate 124 and provide temperature measurements to the controller 338. Thermal sensors 352 may also be positioned below the susceptor 340 to measure the temperatures of the substrate 124. The heating assembly 301 may also include a plurality of cooling zones for cooling the heating assembly 301. Detailed descriptions of the heating assembly 301 will be provided later in the present disclosure with reference to other drawings.

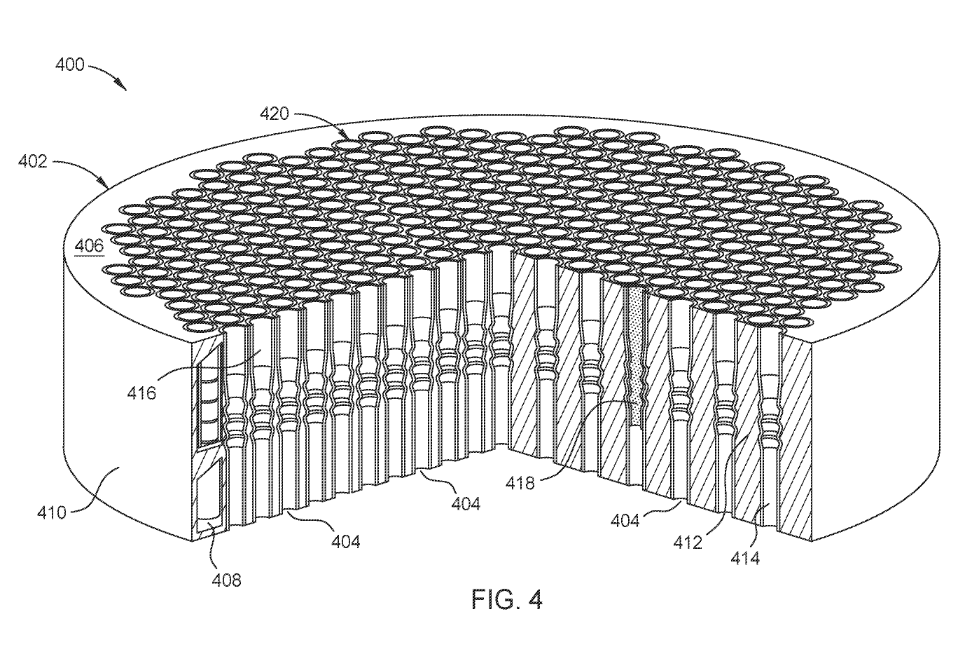

FIG. 4 illustrates a schematic perspective and cross-sectional view of a heating assembly 400 (lamps are removed), according to an embodiment of the present disclosure. When heating lamps are not disposed, the heating assembly 400 may also be understood as the reflector apparatus 332 (shown in FIG. 2). The heating assembly 400 may be representative of any of the heating assembly 224 and 301. The heating assembly 400 includes a base 402 and a plurality of reflector pockets 404 formed in the base 402. In an embodiment, the base 402 has a cylindrical shape and has a first side 406, a second side 408, and a side wall 410. The first side 406 may be understood as a front side that faces a susceptor or a substrate when the heating assembly 400 is placed in a processing chamber. The first side 406 has openings 420 that allow radiation to pass through and may also be called a front side or a radiation side. The second side 408 has sockets configured to couple with heating lamps and may be called a back side or a socket side. The first side 406 and the second side 408 form two opposite sides of the base 402. The second side 408 faces away from the susceptor. The side wall 410 extends between the radiation side 406 and the socket side 408 and forms a perimeter of the base 402.

The heating assembly 400 may be disposed below a susceptor or above a susceptor. When the heating assembly 400 is disposed in a deposition chamber at a location below a susceptor, the first side 406 defines a front surface of the base 402. The second side 408 defines a back surface of the base 402. When the heating assembly 400 is disposed in a RTP chamber at a location above the susceptor, the first side 406 defines a back surface of the base 402. The second side 408 defines a front surface of the base 402.

The plurality of reflector pockets 404 are configured to receive heating elements (not shown in FIG. 4), such as radiation lamps. Each reflector pocket includes a reflector 416 configured to reflect radiation emitted by a radiation lamp toward the first side 406 and/or the susceptor 340. Each reflector pocket 404 also has cooling chambers 412 encasing the reflectors 416. To efficiently cool the reflector 416, the cooling chamber 412 encases the reflector 416 like a “jacket.” For example, the cooling chamber 412 substantially conforms to the shapes of the reflector 416. The cooling chamber 412 also circulates a coolant such that substantially the entire walls of the reflectors 416 contact with the coolant.

The base 402 also includes a base cooling chamber 414. The reflector cooling chamber 412 is disposed around the reflector 416 and cools the reflector 416. The base cooling chamber 414 is disposed under the reflector cooling chamber 412 and cools a coupling portion of the radiation lamp. The cooling chambers 412 and 414 extend substantially between the first side 406 and the second side 408. Configurations of the reflector cooling chamber 412 and the base cooling chamber 414 will be explained in detail with reference to other drawings.

The base 402 may be made by an additive manufacturing process, such as a 3D printing process. With an additive manufacturing process, the base 402 can have complex shapes, such as a Fresnel shape for the reflector. The reflectors 416 of the base 402 can also be very thin, such as no greater than 1 mm thick. The base 402 can be subsequently polished and coated by layers of protective materials and/or layers of reflective materials, such as gold. The base 402 may be made of nickel, a nickel-containing supper alloy (such as Inconel), stainless steel, copper, and any other suitable material.

In an embodiment, at least one reflector pocket is left unoccupied by a heating element. A light pipe of a pyrometer can use the unoccupied reflector pocket as a passage to measure the temperature of a substrate. A sleeve 418, such as a sapphire sleeve, may be additionally disposed within the unoccupied reflector pocket to protect the light pipe of the pyrometer.

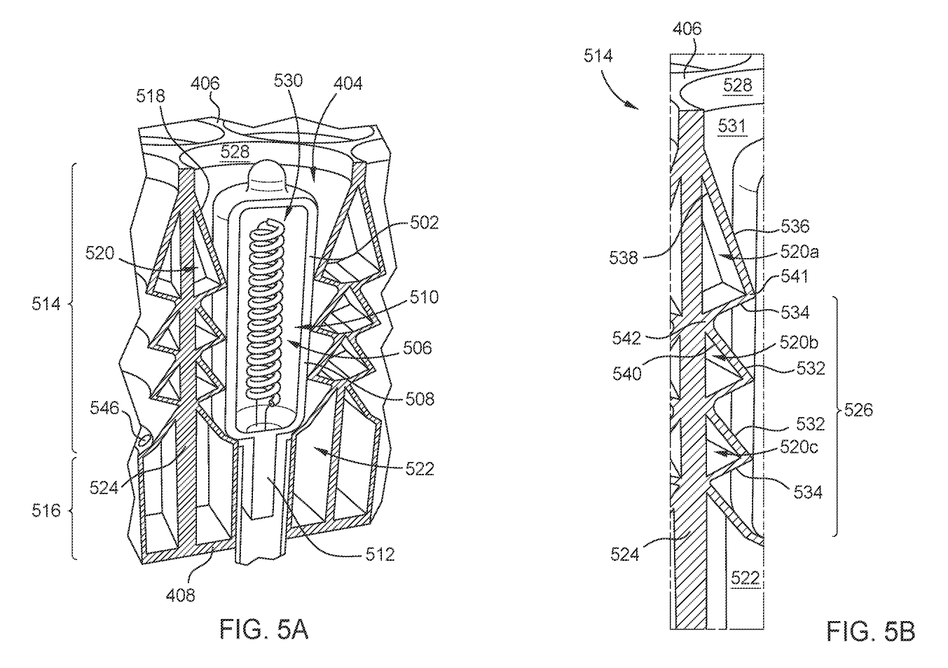

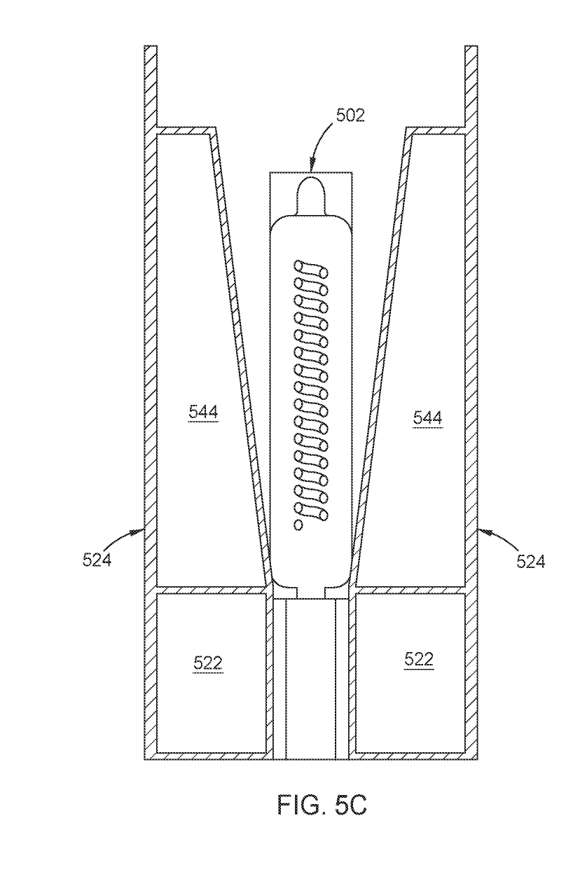

FIG. 5A illustrates a schematic cross-sectional view of a reflector pocket 404 of the heating assembly 400, according to an embodiment of the present disclosure. The cross-sectional view shows that a heating element 502, such as a radiation lamp, is disposed in the reflector pocket 404. The heating element 502 and the reflector pocket 404 are included in the heating assembly 400 as shown in FIG. 4. In an embodiment, the heating element 502 has a heating power of at least 600 W, 800 W, 1,000 W, or even higher. The reflector pocket 404 is configured to direct a large portion of the radiation emitted by the heating element out of the reflector pocket 404. The reflector pocket 404 is also configured to have sufficient cooling capacities such that the heating element 502 can be operated for a long time without suffering any heat related damages. In an example, the cooling capacity of a coolant encasing the reflector pocket 404 can keep the temperature of a reflector wall 518 below 100^{o} C. A heating element 502 disposed in the reflector pocket 404 can be operated at 800 W for longer than 10 minutes without showing any damage, such as deformation or meltdown of an external housing.

As shown in FIG. 5A, the heating element 502 includes a radiation portion 510 and a coupling portion 512. The radiation portion 510 includes a filament 506 enclosed by a housing 508. During operation, the filament 506 generates radiation which can be absorbed by a susceptor to generate heat. The radiation can also be absorbed by and heat other components, which may not desired. The housing 508 protects the filament and may be made of a transparent material, such as quartz, and may be referred to as a bulb. The coupling portion 512 is configured to secure the heating element 502 in the reflector pocket 404. The coupling portion 512 includes electrical connections that supply electricity to the filament 506.

In an embodiment, the reflector pocket 404 is divided into a reflector portion 514 and a base portion 516. The reflector portion 514 is disposed at locations that surround the radiation portion 510 of the heating lamp 502 and includes reflective surfaces configured to direct radiation of the heating element 502 toward predetermined directions. The base portion 516 is disposed below the reflector portion 514 and adjacent to the socket side 408 of the heating assembly 400. The base portion 516 is configured to engage with and secure the coupling portion 512 of the heating lamp 502. In an embodiment, both the reflector portion 514 and the base portion 516 include 3D printed materials, which may include nickel, nickel-containing supper alloy (Inconel), stainless steel, copper, or any other suitable material.

In an embodiment, a purge gas outlet 546 is disposed inside the reflector pocket 404. The purge gas outlet 546 allows a purge gas, such as helium, to flow into each reflector pocket. The flow of the purge gas can cool the heating element 502. The purge gas outlet 546 may be disposed above the coupling portion 516 and below the heating filament 506.

FIG. 5B illustrates an enlarged partial view of a portion of the reflector portion 514, according to an embodiment of the present disclosure. The reflector portion 514 includes a reflector wall 518 and a plurality of reflector cooling chambers 520a, 520b, 520c. The reflector wall 518 has a reflective surface 531, which may be made of gold or any other suitable material. A polishing process or a plating process or any other suitable process may be used to make the surface reflective.

In an embodiment, the reflector portion 514 may include several sections configured to direct radiation toward predetermined directions. The reflector portion 514 may include a cylindrical section 528 and a wavy section 526 (shown in FIG. 5B). A transition section 536 is disposed between the cylindrical section 528 and the wavy section 526. In some embodiments, the transition section 536 can be considered part of the wavy section 526 itself. The cylindrical section 528 is disposed adjacent to the radiation side 406 and above a top end 530 of the filament 506. The wavy section 526 substantially surrounds the filament 506. In an embodiment, the wavy section 526 has a plurality of upward facing surfaces 532 facing toward the radiation side 406 and a plurality of downward facing surface 534 facing toward the socket side 408. The upward facing surfaces 532 and the downward facing surfaces 534 may be linear or curved. In an embodiment, the upward facing surfaces 532 and 534 are linear surface, and a Fresnel shape can be formed by the plurality of the upward facing surfaces 532 and downward facing surfaces 534.

The transition section 536 also faces toward the radiation side 406. In an embodiment, the transition section 536 has a linear surface with an inclination angle different from the upward facing surface 532. For example, the transition section 536 forms a first angle 538 with the vertical wall 524, and the upward facing surface 532 forms a second angle 540 with the vertical wall 524. The first angle 538 is smaller than the second angle 540. The transition section 536 may have a frustum shape. In addition, some of the upward facing surfaces 532 of the wavy section wavy section 526 may be positioned at different inclination angles relative to the vertical wall 524 or a central vertical axis of the reflector pocket, or in other embodiments the upward facing surfaces 532 may be positioned at the same angle relative to the vertical wall 524 or central vertical axis of the reflector pocket.

The reflector cooling chambers 520a, 520b, 520c are formed behind the reflector wall 518. The reflector cooling chambers 520a, 520b, 520c allow a heat transferring fluid, such as water, to be circulated to remove heat from the reflector wall 518, which, in turn, lowers the temperature of the housing 508. The reflector cooling chambers 520a, 520b, and 520c may form a cooling jacket encasing the heating element 520.

In an embodiment, the reflector wall 518 has a Fresnel shape with peaks 541 and valleys 542 corresponding to high and low temperature areas of the heating filament 506. The peaks 541 and valleys 542 may form a sawtooth shape in a cross sectional view of the reflector apparatus. The Fresnel shape can maximize light output of the reflector while also efficiently cooling the housing 508 of the heating elements. In an embodiment, a peak 541 of the Fresnel shape is less than about 1 mm or 0.5 mm away from the housing 508 of the heating element 502. The valleys 542 are positioned further from the housing 508 than the peaks 541. For example, the valleys 542 can be more than 1 mm away from the housing 508 of the heating element.

The base portion 516 of the reflector pocket 404 includes a base cooling chamber 522 configured to circulate the heat transferring fluid (not shown), such as water. The base cooling chamber 522 surrounds and cools the coupling portion 512 of the heating element 502. In an embodiment, the base cooling chamber 522 is a return plenum and fluidly connected with the reflector cooling chambers 520a, 520b, 520c. The base cooling chamber 52 receives the heat transferring fluid from the reflector cooling chamber 520a, 520b, and 520c and directs the heat transferring fluid to an outlet (not shown in FIG. 5B). The circulation of the heat transferring fluid in the cooling chambers will be further described later with reference to other drawings.

In an embodiment, the reflector pocket 404 also includes a vertical wall 524 extending between the radiation side 406 and the socket side 408. The reflector portion 514 is attached to the vertical wall 524.

In one or more embodiments, the reflector cooling chamber 520a extends to a location higher than the top end 530 of the filament 506. The reflector cooling chambers 520a, 520b, 520c are fluidly connected and wind around the radiation portion 510 of the heating elements.

As shown in FIG. 5C, the reflector cooling chambers 520a, 520b, 520c may merge into a single reflector cooling chamber 544. The reflector cooling chamber 544 may have a cross-section shaped like a triangle, a rectangle, a trapezoid, or any other shape. In an embodiment, the reflector cooling chamber 544 (shown in FIG. 5C) may also merge with the base cooling chamber 522.

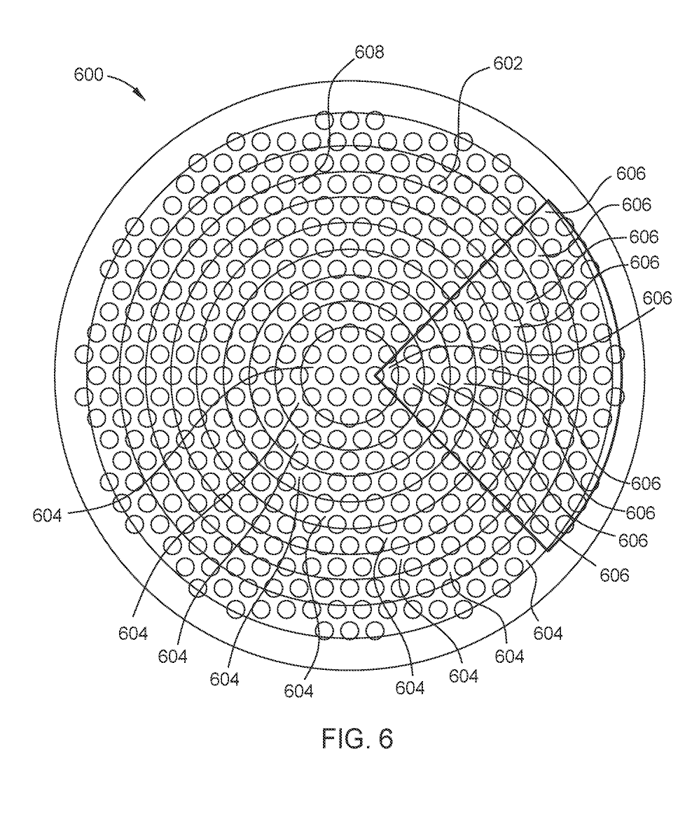

FIG. 6 illustrates a schematic control groups of a heating assembly 600, according to an embodiment of the present disclosure. The heating elements 602 of the heating assembly 600 may be divided into a plurality of annular bands 608, which are concentric to one another. Each annular band 608 may be divided into two zone groups 604 and 606, which are complementary circular sectors. The zone groups 604 include a plurality of heating elements 602 and may have a circular angle greater 180 degrees. The zone groups 604 are configured to constantly supply energy to the processing chamber. The zone groups 606 also include a plurality of heating elements 602 and may have a circular angle less than 180 degrees. The zone groups 606 are configured to intermittently supply energy to the processing chamber. Electricity can be independently supplied to each of the zone groups 604, 606 to adjust their heating powers. As a result, the uniformity of temperature on a substrate can be better controlled.

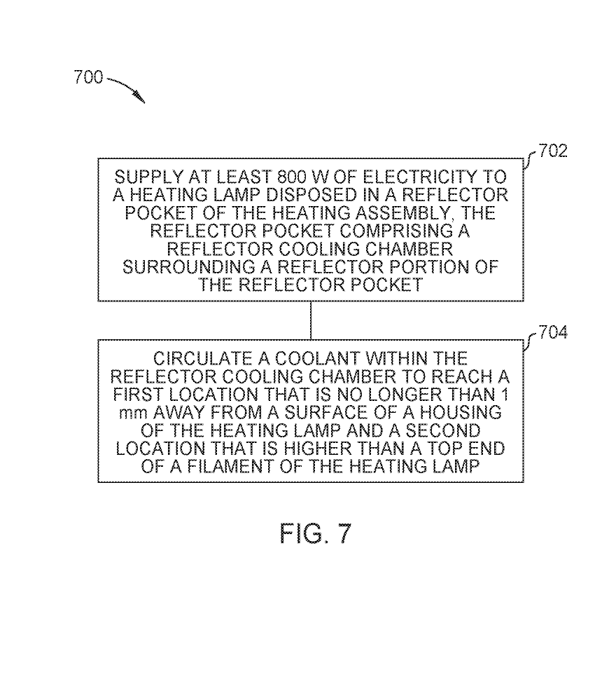

FIG. 7 illustrates a method for operating a heating assembly, according to an embodiment of the present disclosure. In an embodiment, the heating assembly is used in a processing chamber for supplying heat to process a SiC substrate. The heating assembly is disposed below a susceptor supporting a SiC substrate. The heating lamps of the heating assembly are capable of rapidly heating the susceptor and the SiC substrate at 40^{o} C/second and to a temperature of at least 1,000^{o} C, 1,500^{o} C, 1,800^{o} C, or higher. At operation 702, at least 800 W of an electrical power is supplied to a heating lamp disposed in a reflector pocket of the heating assembly. The reflector pocket includes a reflector cooling chamber encasing a reflector portion of the reflector pocket. The heating lamp has a housing made of quartz or other transparent material. The electrical power may be supplied for at least 10 minutes or longer. At operation 704, a coolant is circulated within the reflector cooling chamber to reach a first location that is no longer than 1 mm away from a surface of the housing of the heating lamp and a second location that is higher than a top end of a filament of the heating lamp. The coolant may also be circulated within a base cooling chamber encasing a coupling portion of the heating lamp. The base cooling chamber is disposed under the reflector cooling chamber. The cooling chambers are capable of keeping a temperature of the reflector portion no higher than 100 ^{o} C, which is well below the softening point of the housing.

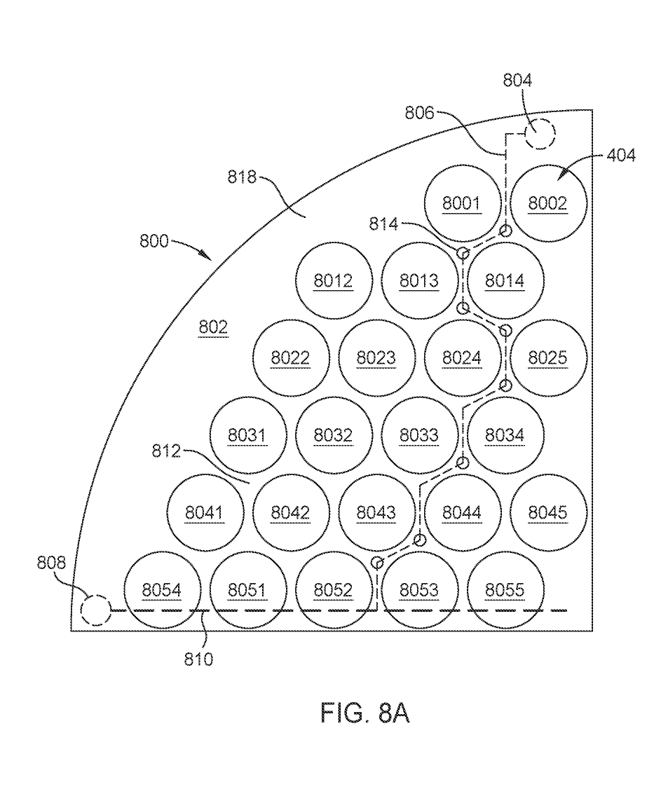

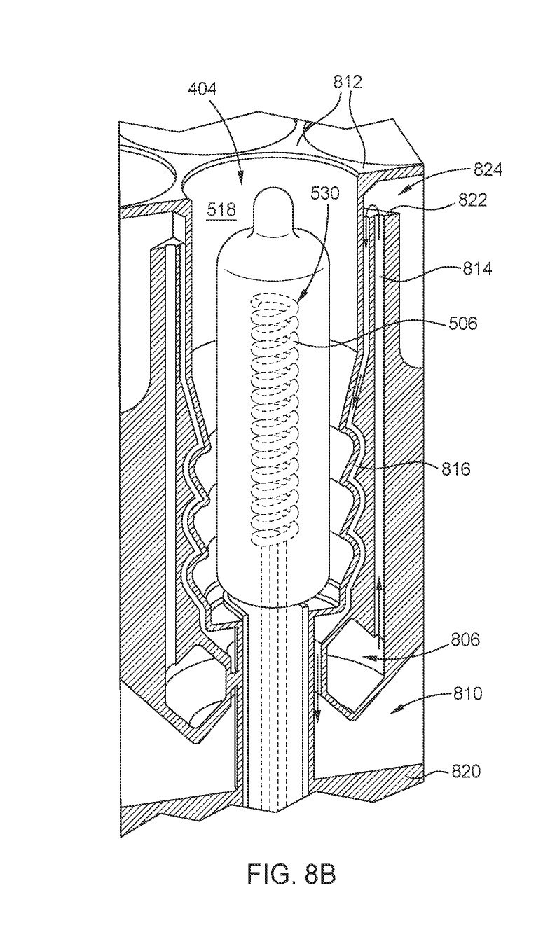

FIG. 8A illustrates a schematic top view of a cooling zone of a heating assembly, according to an embodiment of the present disclosure. The cooling zone 800 occupies a quarter circle of the heating assembly 400. Thus, the heating assembly 400 may include at four (4) cooling zones 400. In an embodiment, the cooling zone 800 is not limited to a quarter circle and may occupy a circular sector of various angles, such as 60 degrees and 30 degrees. The cooling zone 800 may also be other shapes, such as rectangular or trapezoid. The cooling zone 800 may be divided independently from the heating groups shown in FIG. 6.

The cooling zone 800 includes a circulation network 818 configured to circulate a heat transferring fluid to cool a plurality of heating lamps 8001-8055 disposed within the cooling zone 800. The circulation network 818 is capable of delivering a heat transferring fluid to every reflector pocket.

As shown in FIG. 8A, the circulation network 818 includes a coolant inlet 804, a supply plenum 806, a return plenum 810, and a coolant outlet. The coolant inlet 804 receives a pressurized heat transferring fluid and directs the pressurized heat transferring fluid to the supply plenum 806, which extends to every reflector pocket of the cooling zone 800. The heat transferring fluid flows from the supply plenum to cooling chambers 816 of the reflector pockets, which direct the heat transferring fluid to the return plenum 810. The return plenum 810 also extends to every reflector pocket of the cooling zone and directs the heat transferring fluid to the coolant outlet 808.

To deliver the heat transferring fluid in a vertical direction, the circulation network 818 includes a plurality of vertical channels 814. In an embodiment, the vertical channels 814 are disposed within the interstices 812 formed by adjacent reflector pockets. As the reflector pockets are arranged hexagonally, each reflector pocket is adjacent to a plurality of interstices 812, such as three (3) interstices 812, which can be used for supporting cooling channels. In an embodiment, each interstice includes at least one vertical channel 814. The vertical channel 814 is configured to flow a heat transferring fluid vertically to the cooling chambers of all the adjacent reflector pockets. In another embodiment, the circulation network 818 is capable of flowing the heat transferring fluid to a location that is above a heating lamp.

FIG. 8B illustrates a schematic cross-sectional view of the circulation network 818, according to an embodiment of the present disclosure. The return plenum 810 is disposed adjacent to a socket side 820 of a heating assembly. The supply plenum 810 is disposed above the return plenum 810 and below the heating filament 506. Both the supply plenum 810 and the return plenum 820 surround the coupling portion of the reflector pocket 404. The vertical channel 814 is fluidly coupled with the supply plenum 806 and is substantially vertical. The vertical channel includes a top outlet 822 that allows the heat transferring fluid to be released into a cooling chamber 824, which is fluidly coupled with a cooling chamber 816 and is disposed adjacent to the first side of the heating assembly. The cooling chamber 824 serves as a common chamber for all adjacent reflector pockets and provides the heating transferring fluid to cooling chambers 816 of all adjacent reflector pockets. In an embodiment, the cooling chamber 816 is shaped like a jacket that conforms to the shape of the reflector wall 518 of the reflector pocket 404. The cooling chamber 816 guides the heat transferring fluid to flow around the reflector wall 518 and releases the heat transferring fluid to the return plenum 820, which directs the heat transferring fluid to the coolant outlet 808. During operation, a heat transfer fluid is supplied from the supply plenum 806, then is flowed vertically along the vertical channel 814, then is released into the chamber 824, then is flowed into the cooling chamber or cooling jacket 816, and then is released into the return plenum 810. In the embodiment shown in FIG. 8B, the vertical channel 814 flows the heat transferring fluid in a direction from the socket side 820 to the front side. In another embodiment, the flowing direction of the heat transferring fluid may be reversed. For example, the vertical channel 814 flows the heating transferring fluid in a direction from the front side to the socket side 820.

It is contemplated that one or more aspects disclosed herein may be combined. Moreover, it is contemplated that one or more aspects disclosed herein may include some or all of the aforementioned benefits. While the foregoing is directed to embodiments of the present disclosure, other and further embodiments of the disclosure may be devised without departing from the basic scope thereof, and the scope thereof is determined by the claims that follow.

What is claimed is:

1. A reflector apparatus for a processing chamber, comprising:
a base comprising a first side having openings for radiation to pass through, a second side opposite to the first side, and a side wall extending between the first side and the second side; and
a first reflector pocket disposed between the first side and the second side of the base and comprising a first reflector portion, the first reflector portion comprising a wavy section having a plurality of peaks and valleys.

2. The reflector apparatus of claim 1, wherein the wavy section comprises a first upward facing surface facing toward the first side and a first downward facing surface facing toward the second side.

3. The reflector apparatus of claim 2, wherein the wavy section comprises a Fresnel shape comprising the first upward facing surface and the first downward facing surface.

4. The reflector apparatus of claim 2, wherein the wavy section has a sawtooth shape in a cross sectional view of the reflector apparatus.

5. The reflector apparatus of claim 1, wherein the first reflector portion further comprises a cylindrical section disposed above the wavy section.

6. The reflector apparatus of claim 1, wherein the wavy section has a first upward facing surface positioned at a first tilt angle and a second upward facing surface positioned at a second tilt angle different from the first tilt angle.

7. The reflector apparatus of claim 1, wherein the first reflector portion comprises a reflector wall with a thickness of no greater than 1 mm, the reflector wall comprising a reflective coating.

8. The reflector apparatus of claim 7, wherein the reflector wall is made by an additive manufacturing process and comprises a nickel-containing supper alloy, copper, stainless steel, or nickel.

9. The reflector apparatus of claim 1, further comprising:
a cooling chamber covered by the wavy section and having a volume extending between the plurality of the peaks and valleys.

10. The reflector apparatus of claim 1, further comprising:
a second reflector pocket disposed adjacent to the first reflector pocket and comprising a second reflector portion;
a third reflector pocket disposed adjacent to the first reflector pocket and the second reflector pocket and comprising a third reflector portion;
an interstice disposed among the first reflector pocket, the second reflector pocket, and the third reflector pocket; and
a vertical channel disposed within the interstice and configured to flow a heat transferring fluid in a direction from the second side to the first side or from the first side to the second side.

11. A processing chamber comprising:
a substrate support;
the reflector apparatus of claim 1; and
a first heating lamp disposed in the first reflector pocket, wherein the wavy section of the first reflector portion of the first reflector pocket is configured to reflect radiation from the first heating lamp towards the substrate support.

12. A reflector apparatus for a processing chamber, comprising:
a base comprising a first side having openings for radiation to pass through, a second side opposite to the first side, and a side wall extending between the first side and the second side;
a first reflector pocket disposed between the first side and the second side of the base and comprising a first reflector portion; and
a first reflector cooling chamber encasing the first reflector portion and coupled with a vertical channel disposed adjacent to the first reflector cooling chamber, the vertical channel configured to flow a heat transferring fluid in a direction from the second side to the first side or from the first side to the second side.

13. The reflector apparatus of claim 12, further comprising a supply plenum coupled with the first reflector cooling chamber and configured to flow a heat transferring fluid into the first reflector cooling chamber.

14. The reflector apparatus of claim 13, further comprising:
a return plenum disposed adjacent to the second side of the base and configured to receive the heat transferring fluid from the first reflector cooling chamber.

15. The reflector apparatus of claim 12, further comprising:
a second reflector pocket disposed adjacent to the first reflector pocket and comprising a second reflector portion;
a third reflector pocket disposed adjacent to the first reflector pocket and the second reflector pocket and comprising a third reflector portion; and
an interstice disposed among the first reflector pocket, the second reflector pocket, and the third reflector pocket, the vertical channel disposed within the interstice,
wherein the first reflector pocket, the second reflector pocket, and the third reflector pocket share a common cooling chamber disposed adjacent to the first side.

16. The reflector apparatus of claim 12, wherein the first reflector portion comprises wavy section having a Fresnel shape.

17. The reflector apparatus of claim 16, wherein the first reflector cooling chamber forms a jacket encasing the wavy section.

18. The reflector apparatus of claim 17, further comprising a plurality of cooling zones, each cooling zone configured to flow a heat transfer fluid among a subarea of the reflector apparatus.

19. The reflector apparatus of claim 17, wherein the first reflector pocket includes a wavy section having a peak that is less than 1 mm away from a lamp housing.

20. A processing chamber comprising:
a substrate support;
the reflector apparatus of claim 12; and
a first heating lamp disposed within the first reflector pocket, the first reflector pocket configured to reflect radiation from the first heating lamp towards the substrate support, the first heating lamp comprising a filament enclosed by a housing, the first reflector cooling chamber extending beyond a top end of the filament.
